(19) United States
(12) Patent Application Publication
(10) Pub. No.: US 2025/0246871 A1
(43) Pub. Date: Jul. 31, 2025

(54) PACKAGED HIGH-Q REFERENCE CAVITY SYSTEM

(71) Applicant: BAE SYSTEMS Information and Electronic Systems Integration Inc., Nashua, NH (US)

(72) Inventors: Zakary N. Burkley, Amherst, NH (US); Mackenzie A. Van Camp, Lowell, MA (US); Charles J. Turner, Hollis, NH (US); Craig C. Price, Manchester, NH (US); John Jost, Chardonne (CH); Thien An Nguyen, Austin, TX (US); Leif Johansson, Santa Barbara, CA (US)

(21) Appl. No.: 18/426,951

(22) Filed: Jan. 30, 2024

(51) Int. Cl. H01S 3/1112

(52) U.S. Cl. CPC H01S 3/1112

(57) ABSTRACT

Photonic coupling mechanisms are described. In one example, a reference cavity system includes a housing, a photonic integrated circuit disposed within the housing, the photonic integrated circuit including an optical waveguide network, the optical waveguide network including at least a first optical waveguide and a second optical waveguide, and a crystalline microresonator disposed within the housing. Examples of the reference cavity system further include a photonic wirebond having first and second end regions coupled to the first and second optical waveguides, respectively, and a loopback portion extending between the first and second end regions, the photonic wirebond extending away from the photonic integrated circuit toward the crystalline microresonator and configured to couple light between the optical waveguide network and the crystalline microresonator via evanescent coupling.

### STATEMENT OF GOVERNMENT INTEREST

This invention was made with United States Government assistance under Grant No. HR001122C0039 awarded by the Defense Advanced Research Projects Agency. The United States Government has certain rights in this invention.

### FIELD OF DISCLOSURE

The present disclosure relates to photonic systems and, more particularly, to a compact packaged reference cavity for photonic applications.

### BACKGROUND

High-Q optical microresonators provide a number of useful properties for a wide variety of photonic applications. In particular, bulk crystalline microresonators have several attractive properties and offer advantages over photonic integrated circuit-based microresonators in terms of optical power specifications and ease of manufacture. However, optical coupling to crystalline microresonators remains a significant challenge. For instance, such optical coupling can be accomplished with free-space optical couplers, such as prisms, tapered optical fibers, or angle-cleaved optical fibers, but such optical elements are bulky, fragile, and/or difficult to manufacture. Accordingly, non-trivial issues remain with respect to using crystalline microresonators in photonic systems.

### SUMMARY

Aspects and embodiments are directed to techniques for coupling to crystalline microresonators and providing compact packaged devices that incorporate crystalline microresonators.

According to one embodiment, a reference cavity system comprises a housing, a photonic integrated circuit disposed within the housing, the photonic integrated circuit including an optical waveguide network, the optical waveguide network including at least a first optical waveguide and a second optical waveguide, a crystalline microresonator disposed within the housing, and a photonic wirebond having first and second end regions coupled to the first and second optical waveguides, respectively, and a loopback portion extending between the first and second end regions, the photonic wirebond extending away from the photonic integrated circuit toward the crystalline microresonator and configured to couple light between the optical waveguide network and the crystalline microresonator via evanescent coupling.

According to another embodiment, a packaged reference cavity system comprises a housing having an internal volume of less than 20 cubic centimeters, a photonic integrated circuit disposed within the housing, the photonic integrated circuit including an optical waveguide network, a crystalline microresonator disposed within the housing, the crystalline microresonator having a circular cross-section and including an annular protrusion extending around a circumference of the crystalline microresonator, and a photonic wirebond coupled to the optical waveguide network and having a loop portion extending away from the photonic integrated circuit to contact the annular protrusion of the crystalline microresonator, the photonic wirebond configured to couple light between the optical waveguide network and the crystalline microresonator via evanescent coupling.

According to another embodiment, a photonic system comprises a laser system configured to output a laser beam having a laser frequency, a reference cavity system configured to produce a reference resonance for the laser frequency, and an optical fiber bundle configured to couple the laser beam between the laser system and the reference cavity system. The reference cavity system may comprise a housing, a photonic integrated circuit disposed within the housing, the photonic integrated circuit including an optical waveguide network, a crystalline microresonator disposed within the housing, and a photonic wirebond coupled to the optical waveguide network and positioned to couple light from the laser beam between the optical waveguide network and the crystalline microresonator via evanescent coupling. The photonic system can be configured to lock the laser frequency to the reference resonance.

Still other aspects, embodiments, and advantages of these example aspects and embodiments are described in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

### In the Figures:

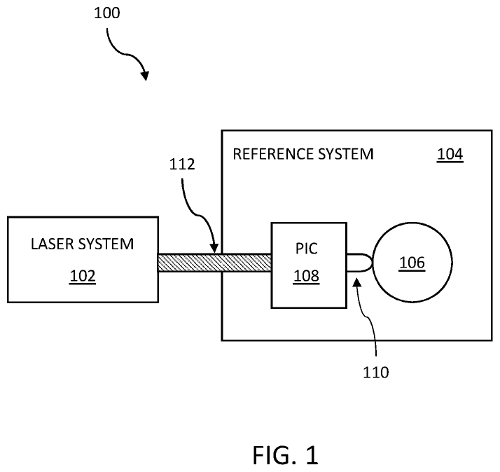

FIG. 1 is a block diagram of a photonic system according to an embodiment disclosed herein;

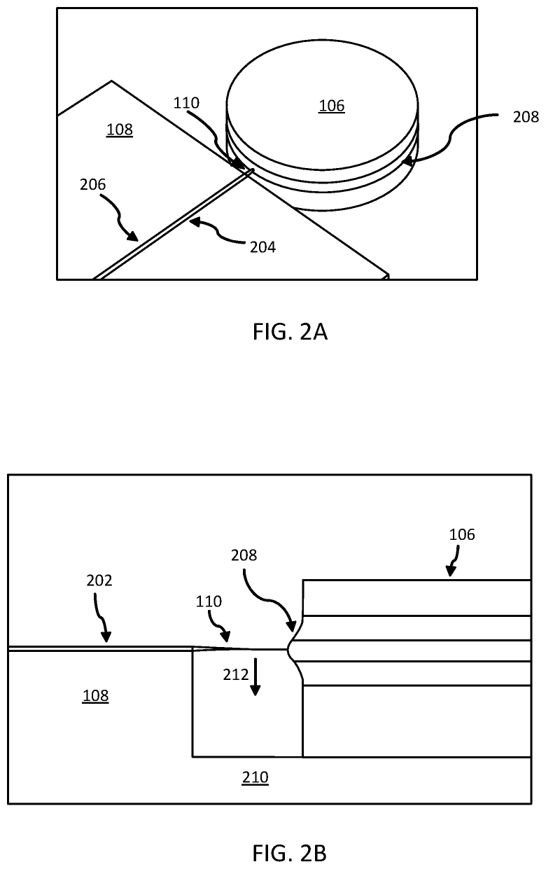

FIG. 2A is a diagram illustrating a perspective view of an example of a photonic wirebond providing a coupling mechanism between a photonic integrated circuit and a crystalline microresonator according to an embodiment disclosed herein;

FIG. 2B is a diagram illustrating a side view of an example of a photonic wirebond providing a coupling mechanism between a photonic integrated circuit and a crystalline microresonator according to an embodiment disclosed herein;

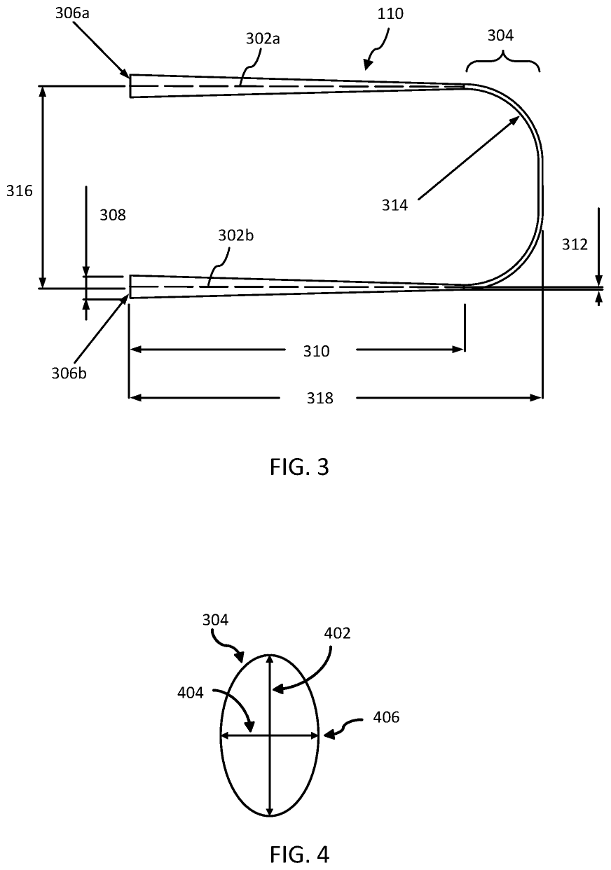

FIG. 3 is diagram of one example of a loopback photonic wirebond according to an embodiment disclosed herein;

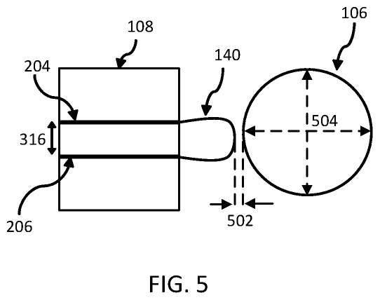

FIG. 4 is a diagram showing a portion of the loopback photonic wirebond of FIG. 3 having an elliptical profile according to an embodiment disclosed herein;

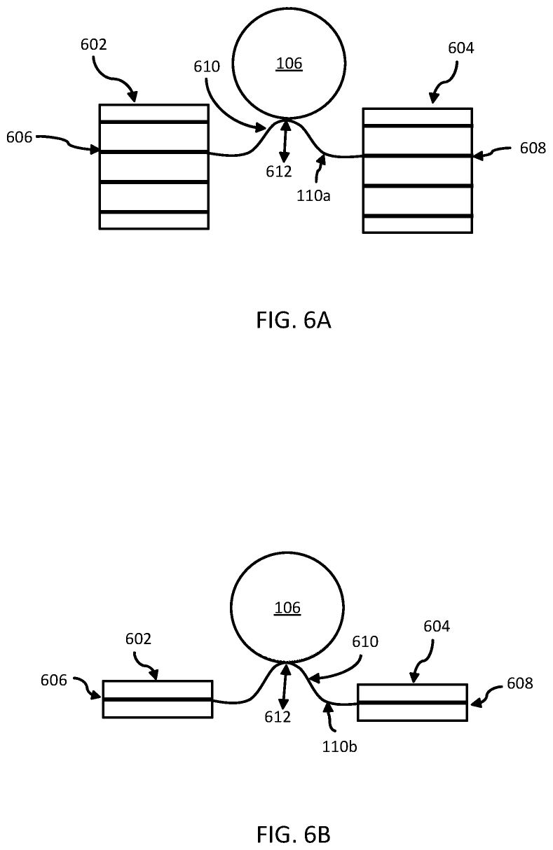

FIG. 5 is a diagram illustrating a plan view (top-down) of an example of a loopback photonic wirebond and a microresonator according to an embodiment disclosed herein;

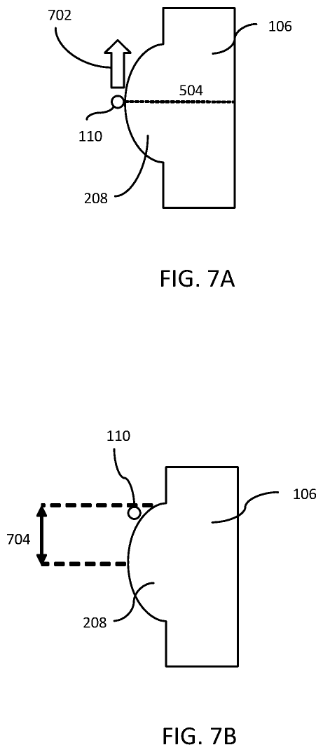

FIG. 6A is a diagram illustrating a plan view (top-down) of an example of a lateral loop photonic wirebond according to an embodiment disclosed herein;

FIG. 6B is a diagram illustrating a plan view (top-down) of an example of a vertical loop photonic wirebond according to an embodiment disclosed herein;

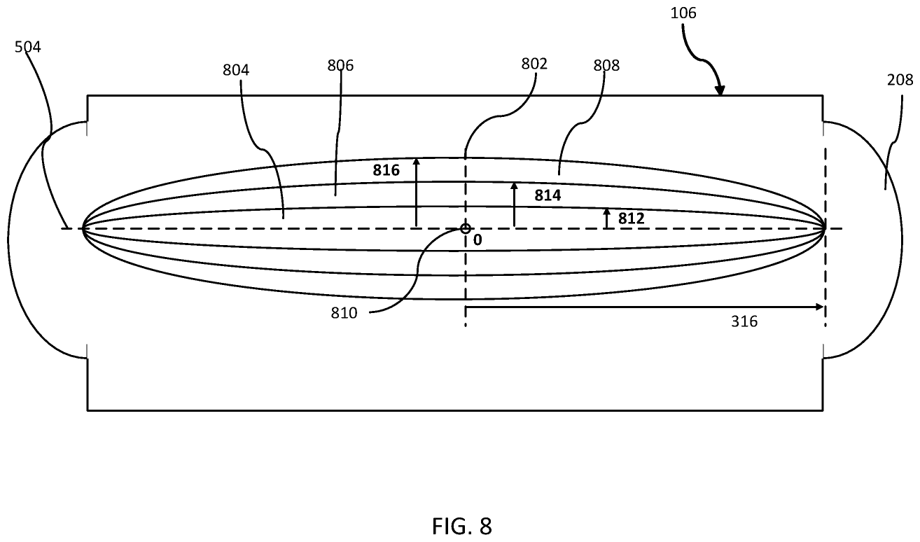

FIG. 7A is a diagram illustrating a side view of an example of a photonic wirebond in a first position relative to a microresonator, according to an embodiment disclosed herein;

FIG. 7B is a diagram illustrating a side view of an example of the photonic wirebond in another position relative to the microresonator, according to an embodiment disclosed herein;

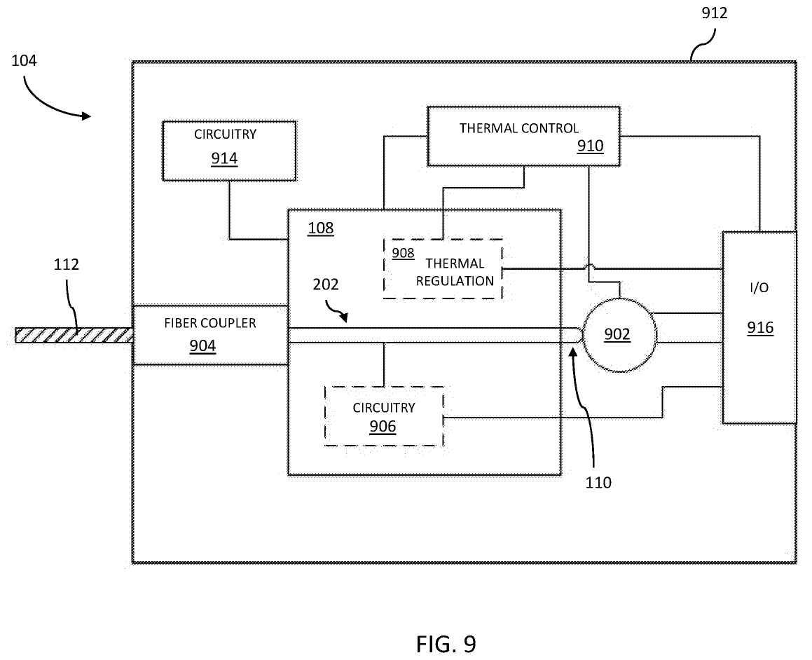

FIG. 8 is a diagram showing a cross-sectional view of an example of a crystalline microresonator with various coupling volumes according to an embodiment disclosed herein e;

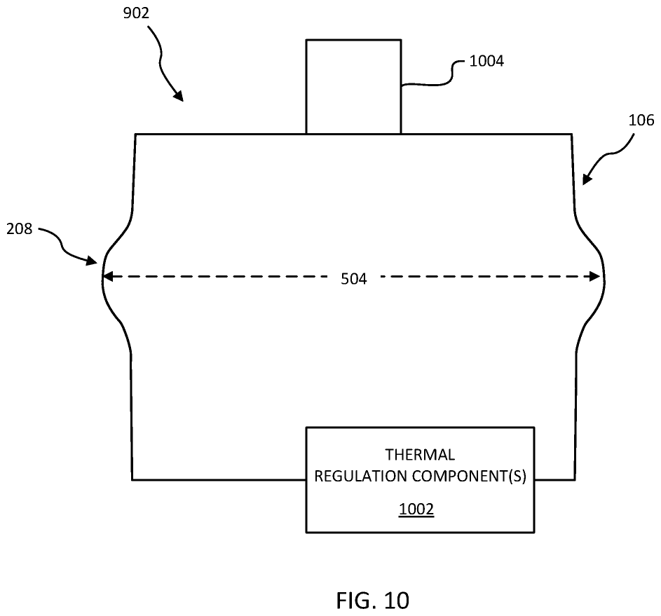

FIG. 9 is a block diagram of an example of a packaged high-Q reference cavity system according to an embodiment disclosed herein;

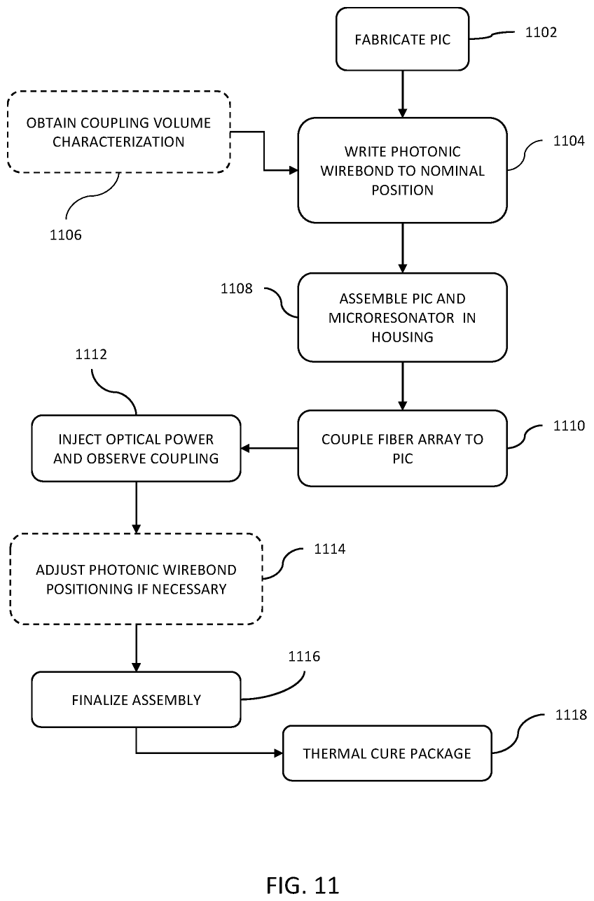

FIG. 10 is a diagram illustrating an example of a microresonator system according to an embodiment disclosed herein;

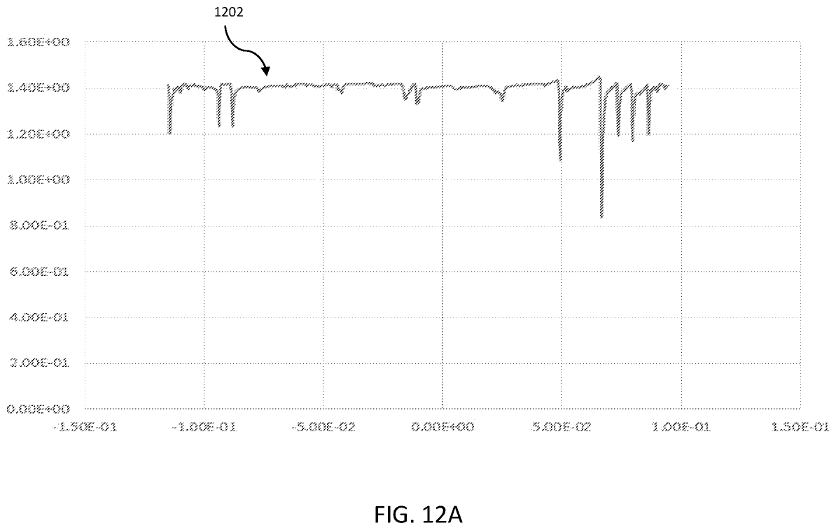

FIG. 11 is a flow diagram illustrating an example of a process for producing a packaged high-Q reference cavity system according to an embodiment disclosed herein;

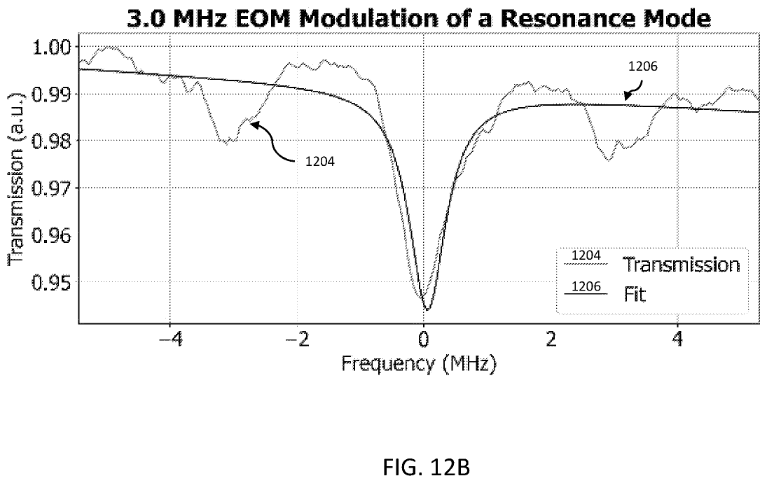

FIG. 12A is a graph showing an example of laser light exhibiting a number of resonance modes according to an embodiment disclosed herein; and

FIG. 12B is a graph illustrating an example of a coupling resonance mode showing transmission in arbitrary units as a function of frequency (MHz), according to an embodiment disclosed herein.

Although the following detailed description will proceed with reference being made to illustrative embodiments, many alternatives, modifications, and variations thereof will be apparent in light of this disclosure.

### DETAILED DESCRIPTION

Techniques are disclosed herein for coupling optical signals between a crystalline optical microresonator and photonic integrated circuit (PIC). The techniques can be used, for instance, to allow for integration of a crystalline microresonator with a PIC in a package that is relatively compact and vibrationally robust. Accordingly, certain examples provide a packaged high-Q reference cavity based on the crystalline optical microresonator and coupling techniques disclosed herein. In some examples, the reference cavity can be used to stabilize, or lock, the frequency of a laser system to a chosen narrow resonance, which can have advantages in numerous applications.

According to certain examples, a reference cavity system includes a housing, a photonic integrated circuit disposed within the housing, and a crystalline microresonator disposed within the housing. The photonic integrated circuit may include an optical waveguide network, the optical waveguide network including at least a first optical waveguide and a second optical waveguide, for example. In some examples, the reference cavity system further includes a photonic wirebond configured to couple light between the optical waveguide network and the crystalline microresonator via evanescent coupling. In some examples, the photonic wirebond has first and second end regions coupled to the first and second optical waveguides, respectively, and a loopback portion extending between the first and second end regions. The photonic wirebond can be arranged to extend away from the photonic integrated circuit toward the crystalline microresonator and optionally to contact the crystalline microresonator. The housing can be relatively compact.

### General Overview

High-Q, or high-finesse, optical microresonators have properties that provide numerous advantages and opportunities in various fields of modern photonics. Their small size and high optical field density provide an opportunity to generate various nonlinear effects at low input optical power and low power consumption within a scalable and compact form factor. One application of high-finesse microresonators is laser frequency stabilization. There are numerous applications that may benefit from the use of a laser having a very narrow linewidth; that is, a laser in which all or most output optical power is concentrated in a narrow frequency band. For example, such lasers may be used for precision physics applications, such as atomic spectroscopy, or other applications in which it is desirable to have minimal frequency noise. One approach by which a narrow linewidth can be achieved includes locking the laser frequency to a high-finesse reference cavity or microresonator. However, achieving good, reliable optical coupling between the laser and the reference microresonator can be challenging.

There are two types of microresonators that are used in photonics applications, those that are located on (or integrated with) a PIC (referred to as PIC-based microresonators) and those that are separate from the PIC (e.g., bulk crystalline microresonators). Crystalline optical microresonators offer several advantages over PIC-based optical microresonators. For example, crystalline optical microresonators can be mass-manufactured from a variety of materials and can support ultra-high quality factors (e.g., Q≈1 billion) within the ultraviolet to mid-infrared wavelength range. In addition, the larger effective mode area (volume) of crystalline microresonators, as compared to their PIC-based equivalents, leads to lower thermorefractive noise (TRN), which can be a limiting factor in laser frequency stabilization. However, despite these advantages over PIC-based microresonators, optical coupling to crystalline optical microresonators is challenging and presents a significant barrier to the use of crystalline optical microresonators in many applications. In more detail, a mechanism is needed to couple light from the PIC into the three-dimensional structure of the optical microresonator that is located off the PIC, and then from the microresonator back into the PIC. Examples of coupling approaches include tapered optical fibers, prisms, angle-cleaved fibers, and grating-based fiber couplers. These approaches, however, are bulky, fragile, sensitive to vibration, and/or involve the use of free-space optical elements. As a result, they are not well-suited for high-volume production. Another possible approach might be use of a free-hanging silica waveguide on a silicon chip to couple to a crystalline microresonator lying on its side. However, such an approach involves relatively complex design, fabrication and alignment procedures, and is susceptible to high losses. The PIC itself can be used to inject light into a crystalline microresonator. However, this coupling approach, while compact, is not suitable for certain crystalline materials, such as low refractive index magnesium fluoride (MgF2) bulk material (n≈1.37 at 1550 nanometers (nm)), which is a preferred material for some photonic applications. Accordingly, non-trivial issues remain with respect to coupling to crystalline optical microresonators and using such microresonators as reference cavities for laser frequency stabilization.

Thus, described herein are techniques for providing a compact, manufacturable, and robust evanescent coupling solution. An example provides a photonic wirebond evanescent coupler configured with a geometry that allows the photonic wirebond to be used to couple light between a PIC and a crystalline optical microresonator. According to some such examples, the photonic wirebond is formed with a loop structure having a geometry (e.g., profile, length, loop dimensions) that is suitable for evanescent coupling with an off-PIC crystalline microresonator. Evanescent coupling is a process by which electromagnetic waves are transmitted from one medium to another via the evanescent, exponentially decaying electromagnetic field. Coupling may be usually accomplished by placing two or more electromagnetic elements, such as optical waveguides, close together so that the evanescent field generated by one element does not decay much before it reaches the other element. For example, evanescent coupling can be achieved though Frustrated Total Internal Reflection (FTIR) in which an evanescent field very close to the surface of a dense medium at which a wave normally undergoes total internal reflection overlaps another dense medium that is close by. This overlap of the evanescent field disrupts the totality of the reflection, diverting some power into the second medium. Using the photonic wirebond as an evanescent coupler allows a high-finesse crystalline microresonator to be packaged with a PIC and associated thermal regulation components and circuitry to produce a compact, vibrationally robust reference system. The reference system can be coupled to a laser system and used for laser frequency stabilization, among various other uses and applications.

For example, according to certain embodiments, a reference cavity system includes a housing, a photonic integrated circuit disposed within the housing, and a crystalline microresonator disposed within the housing. The photonic integrated circuit may include an optical waveguide network formed thereon or otherwise integrated with the PIC, the optical waveguide network including at least a first optical waveguide and a second optical waveguide. The reference cavity system may further include a photonic wirebond coupled to the first and second optical waveguides and configured to couple light between the optical waveguide network and the crystalline microresonator via evanescent coupling. The housing can be relatively compact. For instance, in some cases, the housing is about 10 to 13 centimeters long and about 2.5 to 5 centimeters wide and about 0.5 to 1 centimeter tall. In some such cases, housing has an internal volume of less than about 50 cubic centimeters, less than 20 cubic centimeters, or less than 10 cubic centimeters. Other examples may have different dimensions.

In some such examples, the photonic wirebond has first and second end regions coupled to the first and second optical waveguides, respectively, and a loop portion extending between the first and second end regions. For example, the photonic wirebond may be formed as a loopback photonic wirebond comprising a first tapered end region having a circular profile and tapering in diameter from a first diameter at a first end face to a second diameter at a first point a first length away from the first end face, a second tapered end region having the circular profile and tapering in diameter from the first diameter at a second end face to the second diameter at a second point the first length away from the second end face, and a loop portion extending from the first point to the second point. The loop portion may have an elliptical profile with the second diameter in a first dimension and a third diameter in a second dimension perpendicular to the first dimension, the third diameter being larger than the second diameter. The first and second end faces can be written to connection facets of the first and second optical waveguides so as to couple the photonic wirebond to the at first and second optical waveguides.

In some examples, the crystalline microresonator has a circular cross-section and including an annular protrusion extending around a circumference of the crystalline microresonator. The photonic wirebond can be configured such that the loop portion is proximate or in contact with the annular protrusion of the crystalline microresonator to thereby couple light into and out of the microresonator via evanescent coupling. The reference cavity can be used for a variety of photonics applications, including for laser frequency stabilization of a laser system.

These and other features of photonic systems employing photonic wirebonds and associated methods are described in more detail below.

### Example Device Architecture

FIG. 1 is a block diagram of a photonic system 100 according to an example. The photonic system 100 includes a laser system 102 and a reference system 104. The reference system 104 may be configured to provide a stable, high-Q reference resonance to which the laser frequency can be locked, thereby allowing the laser system 102 to produce an output laser beam with a very narrow linewidth. Accordingly, in some examples, the reference system 104 includes a high-finesse crystalline microresonator 106 and a photonic integrated circuit (PIC) 108. The PIC 108 may include a substrate having an optical waveguide network formed thereon. Light from the laser system 102 is coupled to one or more optical waveguides on the PIC 108 via an optical fiber bundle 112. The optical fiber bundle 112 may include a plurality of optical fibers. Light may be coupled between the PIC 108 and the crystalline microresonator 106 using a photonic wirebond 110. According to certain examples, the photonic wirebond 110 can be used as an evanescent coupler to couple light (e.g., from the laser system 102 or another optical source) between an optical waveguide on the PIC 108 and the off-PIC crystalline optical microresonator 106. As described in more detail below, the photonic wirebond 110 can be formed with various different loop structures to provide the coupling mechanism. Further, the photonic wirebond 110 can be precisely positioned relative to the crystalline microresonator 106 to achieve evanescent coupling with a particular coupling state (e.g., under-coupled, critically coupled, or over-coupled) and extinction ratio, which may be selected based on the application for which the reference system 104 is to be used.

FIGS. 2A and 2B are diagrams illustrating examples of a portion of the reference system 104. FIG. 2A illustrates a perspective view of an example of the reference system 104, including the PIC 108 and the microresonator 106, and FIG. 2B illustrates a side view of an example of the reference system 104 of FIG. 2A. An optical waveguide network 202 is formed on the PIC 108. In the example illustrated in FIG. 2A, the optical waveguide network includes first and second parallel optical waveguides 204, 206; however, in other examples, the optical waveguide network 202 may include more than two optical waveguides, any of which may have any shape or geometry and need not be parallel to one another. In some examples, one or more of the optical waveguides (e.g., optical waveguides 204, 206) making up the optical waveguide network 202 are optical fibers. In other examples, one or more of the optical waveguides making up the optical waveguide network 202 may be formed using other optical waveguide technology.

In certain examples, the photonic wirebond 110 has a “loopback” structure, as shown in FIGS. 1 and 2A. In this example, the photonic wirebond 110 is coupled to the first and second optical waveguides 204, 206, as shown in FIG. 2A, and is configured to form a loop extending away from the PIC 108. In some examples, the photonic wirebond 110 forms a loop that extends in the plane of the PIC 108 towards, and optionally to contact, the microresonator 106. The photonic wirebond 110 operates to couple light from the optical waveguide(s) 204 and/or 206 into the microresonator 106, and from the microresonator 106 back into the optical waveguide(s) 204 and/or 206, via evanescent coupling.

In some examples, the crystalline microresonator 106 includes a protrusion 208. In some examples, the microresonator 106 is circular in cross-section (e.g., generally having a cylindrical shape, as shown in FIGS. 1 and 2A), and the protrusion 208 is an annular protrusion that extends around a circumference of the microresonator 106. Accordingly, the microresonator 106 may have a larger diameter in the region of the protrusion 208 than the diameter of the remainder of the body of the microresonator 106. In some examples, the diameter of the body of the microresonator 106 is in a range of about 1 mm-5 mm. In one example, diameter of the microresonator 106 at a midpoint or “equator” of the protrusion 208 may be extended by approximately 100-200 micrometers (μm) relative to the diameter of the body of the microresonator 106. The microresonator 106 may be made of any of a variety of bulk crystalline materials suitable for photonics applications, including but not limited to, magnesium fluoride (MgF2), for example.

Referring to FIG. 2B, in this example, the photonic wirebond 110 extends from the PIC 108 across a silicon trench 210 to contact (or approach) the protrusion 208 of the microresonator 106. In some examples and orientations of the reference system 104, the downward force of gravity on the photonic wirebond 110 as it extends across the trench 210 (indicated by arrow 212) can cause the photonic wirebond 110 to droop downwards, rather than remain in a perfectly level plane. Accordingly, the alignment of the photonic wirebond 110 with the microresonator 106 and/or the extension length of the photonic wirebond 110 may be tailored to account for some droop. For example, the photonic wirebond 110 can be initially aligned slightly above the midpoint (or “equator”) of the microresonator 106, such that as gravity-induced droop causes the at least the end of the photonic wirebond 110 to bend downwards, the tip region of the loop contacts and rests against the protrusion 122. This configuration may naturally and advantageously provide some resilience or robustness of the coupling to vibration or other mechanical perturbances, as described further below.

Referring now to FIG. 3, there is illustrated a diagram showing a structure and dimensions of the photonic wirebond 110 having a loopback configuration according to some examples. In this example, the photonic wirebond 110 includes two end regions 302a, 302b, and a U-shaped loopback portion 304 extending between the two end regions 302a, 302b. The end regions 302a, 302b have fixed face anchor points 306a, 306b, respectively, that provide a waveguide interface and can be used to anchor the photonic wirebond 110 to optical waveguides, such as the optical waveguides/fibers 204, 206 on the PIC 108, for example. In some examples, the photonic wirebond 110 is a freeform optical waveguide, and the end regions 302a, 302b include tapered portions of the optical waveguide. The tapered portions may have a circular profile (or cross-section). In one example, a first diameter 308 of the tapered portions at the fixed face anchor points 306a, 306b, may be approximately 15 μm (e.g., 15 μm±<10%). The end regions 302a, 302b, may taper in diameter over the length 310 of the individual end regions to a second diameter 312 at a junction with the loopback portion 304. In one example, the second diameter 312 may be approximately 2 μm (e.g., 2 μm±<10%). According to certain examples in which the photonic wirebond 110 is to be used for coupling with a crystalline microresonator 106 made of MgF2, these particular values for the diameters 308, 310 are selected because the effective index (neff) for the fundamental TE mode can be engineered through the photonic wirebond geometry to match that of MgF2. In other examples or for other applications, different diameter values may be selected. In some examples, the length 310 of the end regions 302a, 302b may be at least 40 μm to ensure efficient coupling. For example, the length 310 of the end regions 302a, 302b may be in a range of about 40 μm to 250 μm, or 100 μm to 250 μm, or in some examples, approximately 210 μm (e.g., 210 μm±<10%).

In some examples, the loopback portion 304 includes an elliptical coupler, such that at least a portion of the loopback portion 304 has an elliptical cross-section, as shown in FIG. 4, for example. An elliptical optical waveguide forming the loopback portion 304 may have a major diameter 402 that is approximately double the dimension of the minor diameter 404. In some examples, the minor diameter 404 is selected to substantially match the second diameter 312 (e.g., to be the same as the second diameter within a small or otherwise acceptable margin of error, such as <1%, for example). In one example, the minor diameter 404 is approximately 2 μm (e.g., 2 μm±<10%) and the major diameter 402 is approximately 4 μm (e.g., 4 μm±<10%). The elliptical optical waveguide of the loopback portion 304 may be oriented such that the major diameter is substantially parallel to the surface of the microresonator 106, such that the loopback portion 304 has a contact region 406 that contacts the microresonator 106. The use of an elliptical coupler may be advantageous in that it allows for tuning in two dimensions which may allow individual tuning of different characteristics or parameters of the coupler. For example, the coupling efficiency can be tuned by tuning the minor diameter 404 to keep the optical waveguide of the loopback portion 304 relatively narrow in one dimension, which allows more light to be coupled into the microresonator 120 via a greater extent of the evanescent field (higher coupling efficiency). Tuning the major diameter 402 allows the optical waveguide to made longer in the other dimension, thereby increasing the surface area of the optical waveguide, which allows the photonic wirebond 110 to support higher optical power.

Referring again to FIG. 3, the end regions 302a, 302b and the loopback portion 304 may be regions of a single optical waveguide that is constructed with different geometric properties (e.g., diameter, taper, profile) in the different regions. The loopback portion 304 has a radius of curvature 314. In some examples, the radius of curvature 314 is in a range of about 40 μm to 55 μm, or 45 μm to 50 μm, or in some examples, approximately 48.5 μm (e.g., 48.5 μm±<10%). The photonic wirebond 110 can be configured with a pitch 316 that is the center-to-center spacing between the two end regions 302a, 302b, as shown in FIG. 3. In some examples, the pitch 316 corresponds to the center-to-center spacing between the optical waveguides 204, 206 to which the photonic wirebond 110 is to be coupled. In some examples, the pitch 316 is in a range of about 100 μm to 250 μm, or in some examples, approximately 127 μm (e.g., 127 μm±<10%). In some examples, an extension length 318 of the photonic wirebond 110 is in a range of about 100 μm to 300 μm. Thus, the various aspects of the geometry of the loopback configuration of the photonic wirebond 110 may be selected and tuned so as to provide a coupling mechanism that is capable of handling high optical power, while also being robust and repeatably manufacturable with good reliability. It will be appreciated, however, that photonic wirebonds as described herein may have different dimensions depending on a variety of factors, including the application for which the coupling mechanism is being designed, and the dimensions provided herein are illustrative examples only and not intended to be limiting.

According to certain examples, the photonic wirebond 110 can be manufactured using additive three-dimensional (3D) printing techniques. The use of 3D printing allows the photonic wirebonds 110 to be manufactured with precisely controllable, yet widely variable, dimensions and geometry that can be tailored to specific applications. In other examples, the photonic wirebond 110 can be formed using laser-based deposition and/or etching techniques. Other manufacturing techniques may also be used. In some examples, the photonic wirebond 110 can be made of a photoresist material, for example, a negative-tone photoresist material such as SU-8, for example. The selection of SU-8 may be advantageous in some applications because its refractive index is a good match to the refractive index of MgF2, which may be often used for the microresonator 120. These photonic wirebonds may be written onto the facets of fiber arrays or PICs using a two-photon polymerization process.

As described above, the photonic wirebond 110 operates to couple light from the optical waveguides 204 and/or 306 into the microresonator 106, and from the microresonator 106 back into the optical waveguides 204 and/or 206, via evanescent coupling. Coupling to the microresonator 106 involves refractive index matching between the injected and circulating modes (k-vector matching), and benefits from a large evanescent field extent so as to facilitate light-material interaction. Both of these properties exhibit sensitivity to the geometry of the photonic wirebond 110. Accordingly, the photonic wirebond can be constructed according to examples described with reference to FIGS. 3 and 4 to achieve reliable evanescent coupling with the microresonator 106. Furthermore, in examples, the structure of the photonic wirebond 110 supports input/output ports written to coupling facets of the optical waveguides 204, 206 with relatively low loss and high optical power. In some examples, the total losses from photonic wirebond to optical fiber facet junctions do not exceed 0.85 dB/facet (at a light wavelength of 1550 nm) and support power handling of more than 400 mW.

Testing of the variation in output power from photonic wirebonds 110 having the construction shown in FIG. 3 over varying ambient temperatures ranging from −40° C. to +85° C. and subject to various mechanical stresses revealed an impressively low 0.3 dB peak-to-peak variation, indicating that the loopback photonic wirebonds 110 can reliably support high optical powers over vastly different operating environments. Thus, examples of the photonic wirebond 110 may provide a robust coupling mechanism for crystalline microresonators suitable for a wide range of photonic applications.

As described above, coupling between the photonic wirebond 110 and the microresonator 106 can be controlled by controlling positioning of the photonic wirebond 110 relative to the microresonator 106. For example, referring to FIG. 5, the coupling state (e.g., under-coupled, critically coupled, or over-coupled) can be determined by controlling a gap distance 502 between the loop portion of the photonic wirebond 110 and the protrusion 208 of the microresonator 106. The gap distance 502 may be measured in a plane of the equator 504 of the microresonator 106. In certain examples, the coupling increases with smaller gap distance 502. For example, a gap distance 502 in a range of about of 200 nanometers (nm) to 900 nm may correspond to the under-coupled state, whereas a gap distance 502 of 100 nm or less may corresponding to the over-coupled state. In some examples, the total displacement between under-coupled to over-coupled states is 1.5 μm.

In some examples, the loopback configuration of the photonic wirebond 110, as shown in FIG. 5, for example, may provide a compact and robust coupling mechanism. However, various other loop configurations for the photonic wirebond 110 may be used in some applications. For example, FIGS. 6A and 6B are diagrams illustrating plan (top-down) views of configurations of photonic wirebond 110a, 110b, respectively, in other examples. In these examples, the photonic wirebonds 110a, 110b are coupled between two optical waveguide arrays 602, 604. More particularly, in the examples of FIGS. 6A and 6B, the photonic wirebonds 110a, 110b are coupled between a first optical waveguide 606 that is part of the first optical waveguide array 602 and a second optical waveguide 608 that is part of the second optical waveguide array 604. In some examples, the optical waveguide arrays 602, 604 are optical fiber arrays. In other examples, one or both of the optical waveguide arrays 602, 604 is part of an optical waveguide network formed on a substrate, such as a PIC.

As shown in FIGS. 6A and 6B, the photonic wirebonds 110a, 110b include a loop portion 610 that extends towards and optionally contacts a portion of the crystalline optical microresonator 106. In the example of FIG. 6A, the loop portion 610 of the photonic wirebond 110a extends in the plane of the optical waveguides 606, 608. Accordingly, in this example, the photonic wirebond 110a may be referred to as having a lateral loop structure. In the example of FIG. 6B, the loop portion 610 of the photonic wirebond 110b extends in a plane perpendicular to the plane of the optical waveguides 606, 608. Thus, in FIG. 6B, the optical waveguide arrays 602, 604 are shown in an “edge-on” view. In this example, the photonic wirebond 110b may be referred to as having a vertical loop structure. As described above with reference to FIG. 5, the photonic wirebonds 110a, 110b can be configured (e.g., with a particular extension distance 612 of the loop portion 610) and positioned relative to the microresonator 106 such that the loop portion 610 either contacts the microresonator 106 or is positioned with a certain gap 502 between the tip of the loop portion 610 and a selected region of the microresonator 106.

The configurations of the photonic wirebonds 110a, 110b, shown in FIGS. 6A and 6B may be useful for applications in which, in addition to coupling optical signals into and out of the microresonator 106, it is also desirable to transfer the optical signals from one fiber array to another, or from one PIC to another. Accordingly, referring again to FIG. 1, in such applications, the PIC 108 may be replaced with two PICS (or fiber arrays), at least one of which may be coupled to the laser system 102. The two PICS may be coupled together by a photonic wirebond 110a or 110b, which also provides evanescent coupling with the microresonator 106.

As described above with reference to FIG. 5, adjusting the position the photonic wirebond 110 in the plane of the equator 504 of the microresonator, in particular, controlling the gap distance 502, can influence the coupling state and/or extinction ratio. In some examples, the coupling can also be affected by adjusting the position of the photonic wirebond 110 in a plane perpendicular to the equator 504 of the microresonator 106, as shown in FIG. 7A, for example. In particular, controlling a position of the photonic wirebond 110 in this dimension can influence the coupling in a manner that allows for the generation of non-linear effects within the microresonator 106. This can be useful for various non-linear photonics applications.

Some non-linear photonics applications may involve generating soliton steps in the microresonator 106. MgF2, a material that can be used for the microresonator 106, naturally exhibits anomalous material dispersion in the C-band, which enables microcomb generation without the need for the complicated geometries associated with dispersion engineering. A typical soliton repetition rate for MgF2 microresonators is tens of GHz and, due to their ultra-high Q, the nonlinear power threshold is in the milliwatt range. Accordingly, in some instances, the ability to achieve sufficient coupling between the photonic wirebond 110 and the microresonator 106 to allow for soliton generation may be desirable.

When light is coupled from the laser system 102 into the microresonator 106, under certain resonance conditions, light can build up within the microresonator 106 and as the coupled optical power increases, non-linear effects can start to be observed. These non-linear effects can produce Kerr frequency combs. When the peak optical power circulating in the microresonator 106 crosses a certain threshold, soliton fission occurs and a soliton step is produced. However, coupling to microresonator may need to be precisely controlled in order for soliton generation to occur at particular resonances. Further, while evanescent coupling may be achieved over a range of different positions of the photonic wirebond 110 with respect to the microresonator 106, not all of positions may produce coupling sufficient to generate solitons in the microresonator 106. Accordingly, in applications in which it is desirable to generate solitons, the position of the photonic wirebond 110 relative to the microresonator 106 can be controlled in both the dimension of the gap distance 502 and the perpendicular dimension, indicated by arrow 702 in FIG. 7A. In some such examples, the gap distance 502 can be selected to achieve an over-coupled state, and the positioning in the perpendicular dimension can be controlled to ensure sufficient coupling for soliton generation.

Referring to FIG. 8, there is illustrated a cross-sectional view of a portion of the microresonator 106. FIG. 8 illustrates coupling volume zones within the microresonator 106 corresponding to zones of spatial positioning of the photonic wirebond 110 relative to the equator 504 of the protrusion 208 along a central axis 802 of the microresonator 106 that can result in sufficient evanescent coupling such that solitons may be produced within the microresonator 106. In this example, three coupling volumes, or zones, are illustrated, namely a first coupling volume 804, a second coupling volume 806, and a third coupling volume 808. The first coupling volume 804 corresponds to a zone in which evanescent coupling from the photonic wirebond 110 has a 100% probability of producing resonances with solitons steps (provided the laser system 102 is properly tuned to a resonance condition with the microresonator 106 and the optical beam coupled via the PIC 108 (e.g., via the optical waveguide network 202) has sufficient optical power). The second coupling volume 806 corresponds to a zone in which evanescent coupling from the photonic wirebond 110 has a 50% probability of producing resonances with solitons steps, given the above-noted conditions. The third coupling volume 808 corresponds to a zone in which evanescent coupling from the photonic wirebond 110 has less than 25% probability of producing resonances with solitons steps, even with the above-noted conditions. In some examples, the first coupling volume 804 has a maximum extension 812 along the central axis 802 of 6 μm. In some examples, the second coupling volume 806 has a maximum extension 814 along the central axis 802 of 18 μm. In some examples, the third coupling volume 808 has a maximum extension 816 along the central axis 802 of 36 μm.

According to certain examples, the range of spatial positioning of the photonic wirebond 110 that corresponds to each of the coupling volumes 804, 806, 808 can be determined by positioning the photonic wirebond 110 at various positions relative to the equator 504 of the protrusion 208 of the microresonator 106 and observing the modal profile/spectrum produced at the different positions. For example, FIG. 7A shows the photonic wirebond 110 positioned at a position that corresponds to alignment with the equator 504 along the central axis 802. This position corresponds to the center point 810 shown in FIG. 8. In some examples, during a testing or calibration procedure, for example, the photonic wirebond 110 can be moved to different vertical offset positions relative to the equator 504 of the protrusion 122, as indicated by arrow 702 in FIG. 7A, until a maximum offset position is found at which very few or no non-linearities are observed in the light generated within the microresonator 106. This maximum offset 704 is illustrated in FIG. 7B and corresponds to the maximum vertical extent (or boundary) of the third coupling volume 808 illustrated in FIG. 11. It will be appreciated, although not illustrated in FIGS. 12A-C, that as the photonic wirebond 110 is repositioned in the dimension of the central axis 1102, it may also be necessary to reposition the photonic wirebond in the dimension/plane of the equator 704 so as to maintain a desired coupling state and/or extinction ratio.

In the example illustrated in FIG. 8, the maximum vertical extent (or boundary) of the first coupling volume 804 is at 16 μm, the boundary of the second coupling volume 806 is at 18 μm, the boundary of the third coupling volume 808 is at 36 μm. However, these dimensions may change based on the geometry and dimensions of the photonic wirebond 110 (e.g., as described above with reference to FIGS. 3 and 4) and/or the dimensions of the microresonator 106. Once the dependence of the evanescent coupling on the spatial positioning of the photonic wirebond 110 with respect to the microresonator 106 is known, this information can be used to select an appropriate position of the photonic wirebond 110 based on the coupling needed for a given application.

Referring now to FIG. 9, there is illustrated a block diagram of one example of the reference system 104, which may be implemented using an example of the photonic wirebond 110 and the principles described above. In this example, the reference system 104 includes the PIC 108 and a microresonator system 902 that includes the microresonator 106. The PIC 108 includes the optical waveguide network 202. As described above, in some examples, the optical waveguide network includes two parallel optical waveguides, as illustrated in FIG. 9, such as the optical waveguides 204, 206 of FIG. 2A, for example. However, in other examples, the optical waveguide network 202 may include additional optical waveguides and may have a more complex geometry. The photonic wirebond 110 provides an evanescent coupler to couple light between the optical waveguide network 202 and the microresonator system 902, as described above. In some examples, the reference system 104 includes a fiber coupler 904 that is used to couple light between the optical fiber bundle 112 (which may be coupled to the laser system 102) and the optical waveguide network 202 on the PIC 108. In some examples, the fiber coupler 904 provides optical coupling between one or more of the optical fibers in the optical fiber bundle 112 and one or more of the optical waveguides making up the optical waveguide network 202 with an insertion loss of approximately 1.5 dB per connection facet. The fiber coupler 904 may allow laser light from the laser system 102 to be coupled into the optical waveguide network on the PIC 108, as described above.

According to certain examples, the PIC 108 may include optional photonic circuitry 906. In some examples, the photonic circuitry 906 may include one or more components coupled to the optical waveguide network 202 and/or one or more components that are implemented as part of the optical waveguide network 202. For example, the photonic circuitry 906 may include one or more filters, multiplexors, power splitters, optical amplifiers, optical modulators, photodetectors, and/or other components. Components included in the photonic circuitry 906, if any, may depend on the application for which the reference system 104 is to be used.

In addition, the PIC 108 may include thermal regulation component(s) and/or circuitry 908. For example, as part of element(s) 908, the PIC may include one or more thermoelectric coolers (TECs) to regulate the temperature of the PIC 108 and/or components thereon. The element(s) 908 on the PIC 108 may further include one or more thermistors for temperature sensing. Thermal regulation can be an important aspect of various photonic applications. For example, temperature regulation may be important for accurate laser frequency stabilization. In some examples, the reference system 104 includes off-PIC thermal control circuitry 910 in addition to the on-PIC thermal regulation element(s) 908. The thermal control circuitry 910 may obtain temperature information from one or more temperature sensors (e.g., thermistors) and/or supply control signals to control one or more thermal regulation components (e.g., TECs) to regulate the temperature of the PIC 108 and/or components thereon. Accordingly, the thermal control circuitry 910 may be coupled to the PIC 108 and/or to the thermal regulation component(s) 908, as shown in FIG. 9. In addition, the thermal control circuitry 910 may be coupled to one or more thermal regulation components associated with the microresonator system 902, as described further below.

As described above, in certain examples, the reference system 104 can be provided in a compact integrated package. Accordingly, in some examples, the various components of the reference system 104, including the PIC 108, the microresonator system 902, the fiber coupler 904, and optional additional off-PIC circuitry (e.g., the thermal control circuitry 910 and/or other off-PIC circuitry 914) are housed within a housing 912. In some examples, the housing has a compact form-factor, for example, having an internal volume of less than 20 cubic centimeters, less than 15 cubic centimeters, or less than 10 cubic centimeters. In some such cases, the housing is about 10 to 13 centimeters long and about 2.5 to 5 centimeters wide and about 0.5 to 1 centimeter tall. The housing 912 may include an input/output (I/O) connector 916 to allow various components of the reference system 104 to be electrically coupled to one or more external devices or systems. For example, as shown in FIG. 9, the I/O connector 916 can provide for electrical coupling to the thermal control circuitry 910, the thermal regulation component(s) 908, the circuitry 906, and/or one or more thermal regulation element(s) associated with the microresonator system 902. In addition, the housing 912 may include an opening to allow connection between the optical fiber bundle 112 and the fiber coupler 904.

FIG. 10 illustrates an example of the microresonator system 902. As described above, the microresonator system 902 includes the microresonator 106, which in some examples is a crystalline microresonator made of a bulk crystalline material, such as MgF2, for example. As also described above, the microresonator system 902 may include one or more thermal regulation component(s) 1002, which may be coupled to the crystalline microresonator 106. In some examples, the thermal regulation component(s) 1002 include a TEC, which may be controlled by the thermal control circuitry 910, for example, or by an external system or device that is coupled to the TEC via the I/O connector 916. In some examples, the thermal regulation component(s) 1002 include one or more thermistors, or other temperature sensors, for sensing a temperature of the crystalline microresonator 106. Information from the thermistor(s) may be provided to the thermal control circuitry 910, or to an external system or device via the I/O connector 916. As described above, thermal regulation of the microresonator 106 can be important in some applications, including applications in which the microresonator 106 provides a high-Q reference resonance for locking the output frequency of the laser system 102 to achieve a laser beam with a narrow linewidth.

In some examples, the microresonator system 902 includes a handling component 1004 that is coupled to the microresonator 106. The handling component 1004 may be mechanically attached to the microresonator 106, and the attachment may be permanent or removable. As described above, in some examples, the microresonator 106 is constructed with a very high Q, and therefore may have a polished, finely manufactured surface. In such examples, touching the coupling surface of the microresonator 106 may be undesirable since the contact can degrade the surface quality, which may negatively impact the Q and/or coupling performance of the microresonator 106. Accordingly, the handling component 1004 may provide a mechanism by which the microresonator 106 can be picked up (whether by a person or a machine), positioned within the housing 912, and/or otherwise moved from one position/location to another, without involving any contact with the coupling surface of the microresonator 106. The handling component 1004 may include a screw, bolt, or other protrusion, that can be attached to the top surface of the microresonator 106, or protrude from the body of the microresonator through/away from the top surface of the microresonator 106.

### Example Methodology

FIG. 11 is a flow diagram illustrating an example of a process 1100 for fabricating a reference system 104 according to certain aspects.

At operation 1102, the PIC 108 may be fabricated. In some examples, operation 1102 includes forming the optical waveguide network 202 on a substrate. Operation 1102 may also include populating the substrate with any on-PIC circuitry and/or components, such as the circuitry 906 and/or thermal regulation component(s) 908, and forming any necessary interconnections between various on-PIC devices. In some examples, fabricating the PIC 108 at operation 1102 includes dicing the substrate and performing polishing and/or other steps to finalize fabrication of the PIC 108.

At operation 1104, the photonic wirebond 110 can be written to selected coupling facets of the optical waveguide network 202, as described above. For example, the photonic wirebond 110 may be made of a photoresist material and may be formed using one of the techniques mentioned above (e.g., 3D printing and/or laser etching) and attached to connection facets of the optical waveguide network 202 (e.g., optical waveguides 204, 206) using a two-photon polymerization process or other attachment technique. In some examples, the photonic wirebond 110 can be written at operation 1104 with very precise dimensions and construction to achieve a particular expected spatial positioning relative to the microresonator 106 once the reference system 104 is assembled. For example, an expected distance between the protrusion 208 of the microresonator 106 and an edge of the PIC 108 at which the connection facets of the optical waveguide network 202 are positioned may be known based on a design and planned configuration of the reference system 104 within the housing 912. Accordingly, at operation 1104, the photonic wirebond 110 can be fabricated with appropriate dimensions (e.g., an appropriate extension length 318) based on the design of the reference system 104.

As described above, evanescent coupling between the photonic wirebond 110 and the microresonator 106 may be affected by the spatial positioning of the photonic wirebond 110 relative to the equator 504 of the protrusion 208 of the microresonator 106. Accordingly, in some examples, the process 1100 includes acquiring coupling volume characterization information at operation 1106. As described above, the dependence of the evanescent coupling between the photonic wirebond 110 and the microresonator 106 on the spatial positioning of the photonic wirebond 110 relative to the microresonator 106 can be characterized by placing the photonic wirebond 110 at different positions and observing the modal spectra using an oscilloscope, for example. Once known, this information can be used to write the photonic wirebond 110 to the PIC 108 in such a manner that a desired coupling is achieved. In some examples, the spatial dependence of the coupling can be characterized for a generalized system 100 given a particular set of parameters specifying characteristics of the microresonator 106, the photonic wirebond 110, and the laser system 102. For example, this set of parameters may specify a particular crystalline material (e.g., MgF2) and diameter of the microresonator 106, a structure (e.g., geometric shape) and material of the photonic wirebond 110 (e.g., as discussed above with reference to FIGS. 3 and 4), and certain parameters of the light produced by the laser system 102 (e.g., frequency span, optical power). Once the spatial dependence of the coupling has been characterized for particular type of system 100 with a given set of a parameters, this spatial dependence may be the same, or similar, for other systems 100 with the same set of parameters. Accordingly, in some examples, the characterization need not be performed for each instance of the process 1100. Rather, in some examples, operation 1106 may include obtaining a data set specifying the coupling volume characterization based on spatial positioning of the photonic wirebond in three dimensions.

Based on a known expected arrangement of the PIC 108 and the microresonator system 902 within the housing 912, and based on the coupling volume characterization information acquired at operation 1106, the photonic wirebond 110 can be constructed accordingly for an expected desired coupling performance. For example, the photonic wirebond 110 can be written, based on a known expected distance between the edge of the PIC 108 (where the photonic wirebond 110 is coupled to the optical waveguide network 202) and the microresonator 106, such that droop due to gravity (as described above with reference to FIG. 2B) causes the loop portion 304 to contact the protrusion 208 of the microresonator 106. For non-linear applications in which the generation of solitons is desired, the photonic wirebond can optionally be written such that, when the reference system 104 is assembled, the photonic wirebond is positioned within the region corresponding to the first coupling volume 804, for example.

In some examples, positioning the photonic wirebond 110 such that, once the reference system 104 is assembled, the loop portion 304 of the photonic wirebond 110 will droop onto the protrusion 208 of the microresonator 106 has advantages in terms of coupling performance and robustness. For example, the contact point between the photonic wirebond 110 and protrusion 208 of the microresonator 106 may provide a mechanically robust interface because the photonic wirebond 110 does not readily lose contact with the microresonator 106 under vibration or thermal expansion. In some examples, chemical attraction, such as can der Waals force, between the photonic wirebond and the protrusion 208, acts to hold the photonic wirebond 110 in contact with the microresonator 106. Furthermore, any temperature variation causing thermorefractive changes in the MgF2 material can be compensated for using thermal regulation, as described above with reference to FIGS. 9 and 10.

At operation 1108, the PIC 108 and the microresonator system 902 may be assembled within the housing 912. In some examples, operation 1108 may further include assembling off-PIC circuitry and/or components, such as the fiber coupler 904, the thermal control circuitry 910 and/or the circuitry 914 into the housing 912.

At operation 1110, the laser system 102 can be coupled to the PIC 108 via the optical fiber bundle 112 and the fiber coupler 904.

At operation 1112, the laser system 102 may be controlled to inject optical power into the optical waveguide network 202. Coupling with the microresonator 106 via the photonic wirebond 110 may be observed using a measurement apparatus. For example, a photodetector can be used to sample the optical signal returned from the microresonator 106 into the optical waveguide 202 (and optionally back through one or more optical fibers of the optical fiber bundle 112) and to provide a corresponding electrical signal to an oscilloscope for observation.

FIGS. 12A and 12B are graphs illustrating measurements for an example of the system 100. In this example, the microresonator 106 has a diameter of approximately 5 mm, corresponding to a nominal free spectral range of about 14.2 GHz. FIG. 12A illustrates an example of laser light from the laser system 102 that couples into the microresonator 106. A number of resonance modes (dips in the signal 1202) can be observed. In some examples, the reference system 104 can be used to lock the laser system 102 to one of these resonances and thereby reduce the linewidth. FIG. 12B illustrates a linewidth measurement of a selected resonance mode. In this example, 3 MHZ calibration sidebands from electro-optical modulator were used to modulate the resonance mode. Trace 1204 represents the (normalized) transmitted light from the microresonator 106. As shown, the measured transmitted light 1204 can be fit with a Lorentzian 1206. The full-width half maxima (FWHM) of this Lorentzian 1206 corresponds to the total microresonator linewidth.

Referring again to FIG. 11, if necessary, the process 1100 optionally includes operation 1114 of repositioning the photonic wirebond 110. For example, if the observed coupling at operation 1112 does not meet one or more performance objectives for the application in which the reference system 104 is to be used, the photonic wirebond 110 can be removed and rewritten to a new position. As described above, the photonic wirebond 110 can be made of a photoresistor material, and therefore may be easily removed. A new photonic wirebond can then be written with dimensions, droop, and/or positioning corresponding to a new coupling position with respect to the microresonator 106. Operations 1112 and/or 1114 may be repeated as needed until satisfactory coupling performance for a given application is achieved. In some examples, where the coupling volume characterization information (optionally acquired at operation 1106) is not available or is not sufficiently accurate, operations 1112 and 1114 may be repeated for a variety of different positions of the photonic wirebond 110 and the position with the best coupling performance can be recorded. The photonic wirebond 110 can then be placed at this position for finalization of the package assembly at operation 1116.

At operation 1116, assembly of the packaged reference system 104 is finalized. For example, any final repositioning of components, including the photonic wirebond 110 and/or the microresonator system 902, may be performed. Operation 1116 may include assembly within the housing of any off-PIC circuitry or components not assembled at operation 1108. Operation 1116 may further include forming any connections from components within the housing 912 to the I/O connector 916. An epoxy can then be added and the housing 912 closed and sealed or otherwise fastened in a closed state.

At operation 1116, the packaged reference system 104 may be thermally cured. For example, the package can be thermally cured at a certain temperature (e.g., 70 degrees Celsius) for a certain time period (e.g., 4 hours).

Thus, aspects and embodiments provide photonic wirebond structures that can be used to achieve evanescent coupling between a PIC or optical fiber array and a discrete crystalline optical microresonator to allow for production of a compact, robust reference cavity system that can be used for a variety of photonics applications. Test results demonstrate that good coupling efficiency can be achieved, and that the loopback photonic wirebond structure provides a robust coupling mechanism over a range of different operating conditions.

### FURTHER EXAMPLE EMBODIMENTS

The following examples pertain to further embodiments, from which numerous permutations and configurations will be apparent.

Example 1 provides a reference cavity system comprising a housing, a photonic integrated circuit disposed within the housing, the photonic integrated circuit including an optical waveguide network, the optical waveguide network including at least a first optical waveguide and a second optical waveguide, a crystalline microresonator disposed within the housing, and a photonic wirebond having first and second end regions coupled to the first and second optical waveguides, respectively, and a loopback portion extending between the first and second end regions, the photonic wirebond extending away from the photonic integrated circuit toward the crystalline microresonator and configured to couple light between the optical waveguide network and the crystalline microresonator via evanescent coupling.

Example 2 includes the reference cavity system of Example 1, wherein the loopback portion of the photonic wirebond has an elliptical profile.

Example 3 includes the reference cavity system of Example 2, wherein the first and second end regions of the photonic wirebond each includes a tapered portion having a circular profile, and wherein a diameter of the circular profile substantially matches a minor diameter of the elliptical profile of the loopback portion.

Example 4 includes the reference cavity system of Example 3, wherein the tapered portion has a length in a range of 40 μm to 250 μm.

Example 5 includes the reference cavity system of any one of Examples 1-4, wherein the loopback portion is U-shaped.

Example 6 includes the reference cavity system of any one of Examples 1-5, wherein the loopback portion has a radius of curvature in a range of 40 μm to 55 μm.

Example 7 includes the reference cavity system of any one of Examples 1-6, wherein the photonic wirebond is made of a negative-tone photoresist material.

Example 8 includes the reference cavity system of any one of Examples 1-7, wherein the crystalline microresonator is made of magnesium fluoride.

Example 9 includes the reference cavity system of any one of Examples 1-8, wherein the housing has an internal volume of less than 10 cubic centimeters.

Example 10 includes the reference cavity system of any one of Examples 1-9, further comprising at least one thermal regulation component disposed within the housing and coupled to the photonic integrated circuit.

Example 11 includes the reference cavity system of Example 10, wherein the at least one thermal regulation component is at least one first thermal regulation component, and wherein the reference cavity system further comprises at least one second thermal regulation component disposed within the housing and coupled to the crystalline microresonator.

Example 12 includes the reference cavity system of Example 11, wherein the at least one first thermal regulation component and the at least one second thermal regulation component include thermoelectric coolers.

Example 13 includes the reference cavity system of any one of Examples 1-12, further comprising a fiber coupler coupled to the optical waveguide network.

Example 14 includes the reference cavity system of any one of Examples 1-13, wherein the crystalline microresonator includes an annular protrusion extending around a circumference of the crystalline microresonator; and wherein the photonic wirebond is positioned such that a region of the loopback portion is in contact with the annular protrusion.

Example 15 provides a packaged reference cavity system comprising a housing having an internal volume of less than 20 cubic centimeters, a photonic integrated circuit disposed within the housing, the photonic integrated circuit including an optical waveguide network, a crystalline microresonator disposed within the housing, the crystalline microresonator having a circular cross-section and including an annular protrusion extending around a circumference of the crystalline microresonator, and a photonic wirebond coupled to the optical waveguide network and having a loop portion extending away from the photonic integrated circuit to contact the annular protrusion of the crystalline microresonator, the photonic wirebond configured to couple light between the optical waveguide network and the crystalline microresonator via evanescent coupling.

Example 16 includes the packaged reference cavity system of claim 15, further comprising a first thermal regulation component disposed within the housing and coupled to the photonic integrated circuit, and a second thermal regulation component disposed within the housing and coupled to the crystalline microresonator.

Example 17 includes the packaged reference cavity system of Example 16, wherein the first and second thermal regulation components include thermoelectric coolers.

Example 18 includes the packaged reference cavity system of any one of Examples claim 15-17, wherein the optical waveguide network includes a first optical waveguide and a second optical waveguide, and wherein the photonic wirebond comprising a first end region attached to a first facet of the first optical waveguide, a second end region attached to a second facet of the second optical waveguide, and the loop portion coupled between the first and second end regions.

Example 19 includes the packaged reference cavity system of Example 18, wherein the loop portion has an elliptical profile, and wherein the first and second end regions have a circular profile and are tapered, having a first diameter at the first and second facets, respectively, and a second diameter at respective junctions with the loopback portion, wherein the second diameter is smaller than the first diameter.

Example 20 includes the reference cavity system of Example 19, wherein the first and second end regions each have a length in a range of 40 μm to 250 μm.

Example 21 includes the reference cavity system of any one of Examples 15-20, wherein the loop portion is U-shaped.

Example 22 includes the reference cavity system of any one of Examples 15-21, wherein the loop portion has a radius of curvature in a range of 40 μm to 55 μm.

Example 23 includes the reference cavity system of any one of Examples 15-22, wherein the photonic wirebond is made of a negative-tone photoresist material.

Example 24 includes the packaged reference cavity system of any one of Examples 15-23, wherein the crystalline microresonator is made of MgF2 and the photonic wirebond is made of SU-8.

Example 25 provides a photonic system comprising a laser system configured to output a laser beam having a laser frequency, a reference cavity system configured to produce a reference resonance for the laser frequency, and an optical fiber bundle configured to couple the laser beam between the laser system and the reference cavity system. The reference cavity system comprises a housing, a photonic integrated circuit disposed within the housing, the photonic integrated circuit including an optical waveguide network, a crystalline microresonator disposed within the housing, and a photonic wirebond coupled to the optical waveguide network and positioned to couple light from the laser beam between the optical waveguide network and the crystalline microresonator via evanescent coupling. The photonic system is configured to lock the laser frequency to the reference resonance.

Example 26 includes the photonic system of Example 25, wherein the reference cavity system comprises a first thermal regulation component disposed within the housing and coupled to the photonic integrated circuit, and a second thermal regulation component disposed within the housing and coupled to the crystalline microresonator.

Example 27 includes the photonic system of one of Examples 25 or 26, wherein the crystalline microresonator has a circular cross-section and includes an annular protrusion extending around a circumference of the crystalline microresonator, and wherein the photonic wirebond includes a loop portion extending away from the photonic integrated circuit to contact the annular protrusion of the crystalline microresonator.

Example 28 includes the photonic system of Example 27, wherein the optical waveguide network includes a first optical waveguide and a second optical waveguide, and wherein the photonic wirebond comprises a first tapered end region having a circular profile and tapering in diameter from a first diameter at a first end face coupled to the first optical waveguide to a second diameter at a first point a first length away from the first end face, a second tapered end region having the circular profile and tapering in diameter from the first diameter at a second end face coupled to the second optical waveguide to the second diameter at a second point the first length away from the second end face, and the loop portion extending from the first point to the second point, the loop portion having an elliptical profile with the second diameter in a first dimension and a third diameter in a second dimension perpendicular to the first dimension, the third diameter being larger than the second diameter.

Example 29 includes the photonic system of any one of Examples 25-28, wherein the crystalline microresonator is made of MgF2 and the photonic wirebond is made of SU-8.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A reference cavity system comprising:
a housing;
a photonic integrated circuit disposed within the housing, the photonic integrated circuit including an optical waveguide network, the optical waveguide network including at least a first optical waveguide and a second optical waveguide;
a crystalline microresonator disposed within the housing; and
a photonic wirebond having first and second end regions coupled to the first and second optical waveguides, respectively, and a loopback portion extending between the first and second end regions, the photonic wirebond extending away from the photonic integrated circuit toward the crystalline microresonator and configured to couple light between the optical waveguide network and the crystalline microresonator via evanescent coupling.

2. The reference cavity system of claim 1, wherein the loopback portion of the photonic wirebond has an elliptical profile.

3. The reference cavity system of claim 2, wherein the first and second end regions of the photonic wirebond each includes a tapered portion having a circular profile, and wherein a diameter of the circular profile substantially matches a minor diameter of the elliptical profile of the loopback portion.

4. The reference cavity system of claim 1, wherein the crystalline microresonator is made of magnesium fluoride.

5. The reference cavity system of claim 1, wherein the housing has an internal volume of less than 10 cubic centimeters.

6. The reference cavity system of claim 1, further comprising:
at least one thermal regulation component disposed within the housing and coupled to the photonic integrated circuit.

7. The reference cavity system of claim 6, wherein the at least one thermal regulation component is at least one first thermal regulation component, the reference cavity system further comprising:
at least one second thermal regulation component disposed within the housing and coupled to the crystalline microresonator.

8. The reference cavity system of claim 7, wherein the at least one first thermal regulation component and the at least one second thermal regulation component include thermoelectric coolers.

9. The reference cavity system of claim 1, further comprising:
a fiber coupler coupled to the optical waveguide network.

10. The reference cavity system of claim 1, wherein the crystalline microresonator includes an annular protrusion extending around a circumference of the crystalline microresonator; and wherein the photonic wirebond is positioned such that a region of the loopback portion is in contact with the annular protrusion.

11. A packaged reference cavity system comprising:
a housing having an internal volume of less than 20 cubic centimeters;
a photonic integrated circuit disposed within the housing, the photonic integrated circuit including an optical waveguide network;
a crystalline microresonator disposed within the housing, the crystalline microresonator having a circular cross-section and including an annular protrusion extending around a circumference of the crystalline microresonator; and
a photonic wirebond coupled to the optical waveguide network and having a loop portion extending away from the photonic integrated circuit to contact the annular protrusion of the crystalline microresonator, the photonic wirebond configured to couple light between the optical waveguide network and the crystalline microresonator via evanescent coupling.

12. The packaged reference cavity system of claim 11, further comprising:
a first thermal regulation component disposed within the housing and coupled to the photonic integrated circuit; and
a second thermal regulation component disposed within the housing and coupled to the crystalline microresonator.

13. The packaged reference cavity system of claim 12, wherein the first and second thermal regulation components include thermoelectric coolers.

14. The packaged reference cavity system of claim 11, wherein the optical waveguide network includes a first optical waveguide and a second optical waveguide; and
wherein the photonic wirebond comprising a first end region attached to a first facet of the first optical waveguide, a second end region attached to a second facet of the second optical waveguide, and the loop portion coupled between the first and second end regions.

15. The packaged reference cavity system of claim 14, wherein the loop portion has an elliptical profile, and wherein the first and second end regions have a circular profile and are tapered, having a first diameter at the first and second facets, respectively, and a second diameter at respective junctions with the loop portion, wherein the second diameter is smaller than the first diameter.

16. The packaged reference cavity system of claim 11, wherein the crystalline microresonator is made of MgF2 and the photonic wirebond is made of SU-8.

17. A photonic system comprising:
a laser system configured to output a laser beam having a laser frequency;
a reference cavity system configured to produce a reference resonance for the laser frequency and comprising
a housing,
a photonic integrated circuit disposed within the housing, the photonic integrated circuit including an optical waveguide network,
a crystalline microresonator disposed within the housing, and
a photonic wirebond coupled to the optical waveguide network and positioned to couple light from the laser beam between the optical waveguide network and the crystalline microresonator via evanescent coupling; and
an optical fiber bundle configured to couple the laser beam between the laser system and the reference cavity system;
wherein the photonic system is configured to lock the laser frequency to the reference resonance.

18. The photonic system of claim 17, wherein the reference cavity system comprises
a first thermal regulation component disposed within the housing and coupled to the photonic integrated circuit; and
a second thermal regulation component disposed within the housing and coupled to the crystalline microresonator.

19. The photonic system of claim 17, wherein the crystalline microresonator has a circular cross-section and includes an annular protrusion extending around a circumference of the crystalline microresonator; and
wherein the photonic wirebond includes a loop portion extending away from the photonic integrated circuit to contact the annular protrusion of the crystalline microresonator.

20. The photonic system of claim 19, wherein the optical waveguide network includes a first optical waveguide and a second optical waveguide; and wherein the photonic wirebond comprises
a first tapered end region having a circular profile and tapering in diameter from a first diameter at a first end face coupled to the first optical waveguide to a second diameter at a first point a first length away from the first end face;
a second tapered end region having the circular profile and tapering in diameter from the first diameter at a second end face coupled to the second optical waveguide to the second diameter at a second point the first length away from the second end face; and
the loop portion extending from the first point to the second point, the loop portion having an elliptical profile with the second diameter in a first dimension and a third diameter in a second dimension perpendicular to the first dimension, the third diameter being larger than the second diameter.
